(19) United States
(12) Patent Application Publication
(10) Pub. No.: US 2018/0238292 A1
(43) Pub. Date: Aug. 23, 2018

(54) Ignition device for internal combustion engine

(71) Applicant: Toyota Jidosha Kabushiki Kaisha, Toyota-shi Aichi-ken (JP)

(72) Inventor: Takahiro Tsukagoshi, Susono-shi Shizuoka-ken (JP)

(73) Assignee: Toyota Jidosha Kabushiki Kaisha, Toyota-shi Aichi-ken (JP)

(21) Appl. No.: 15/932,269

(22) Filed: Feb. 16, 2018

(30) Foreign Application Priority Data
Feb. 17, 2017 (JP) 2017-027801

(51) Int. Cl. F02P 5/15

(52) U.S. Cl. CPC F02P 5/1504; F01N 3/2006; F02P 5/151; F02P 5/1516

(57) ABSTRACT

An ignition device for an internal combustion engine includes an ignition plug including a discharge portion facing a vicinity of an exhaust port of a combustion chamber of the internal combustion engine, a drive unit configured to allow nonequilibrium plasma discharge to occur in the discharge portion by applying a drive voltage to the ignition plug, and an electronic control unit configured to allow the nonequilibrium plasma discharge to occur in the discharge portion by applying the drive voltage from the drive unit to the ignition plug in a first predetermined period when the exhaust gas control catalyst is in a warm-up state, the first predetermined period being a predetermined period after initiation of opening of an exhaust valve and a period in which a blowdown phenomenon of exhaust gas occurs.

### CROSS-REFERENCE TO RELATED APPLICATIONS

This application claims priority to Japanese Patent Application No. 2017-027801 filed on Feb. 17, 2017, which is incorporated herein by reference in its entirety including the specification, drawings and abstract.

### BACKGROUND

### 1. Technical Field

The present disclosure relates to an ignition device for an internal combustion engine and, more particularly, to an ignition device capable of generating nonequilibrium plasma of an internal combustion engine.

### 2. Description of Related Art

A configuration provided with a central ignition plug attached such that a discharge electrode faces the center of a combustion chamber and an annular ignition plug attached such that a discharge electrode faces a peripheral edge of the combustion chamber and performing discharge from the annular ignition plug for ignition of an unburned fuel in the vicinity of the exhaust top dead center as well as discharge from the central ignition plug for ignition of an air-fuel mixture in the vicinity of the compression top dead center during warm-up of an exhaust gas control catalyst is known (refer to, for example, Japanese Unexamined Patent Application Publication No. 2010-138750 (JP 2010-138750 A)).

### SUMMARY

The related art described above is based on the knowledge that the unburned fuel adhering to a cylinder bore wall surface is raked up by a piston in an exhaust stroke and the unburned fuel is guided to the peripheral edge of the combustion chamber in the vicinity of the exhaust top dead center after the unburned fuel is raked up. When the piston is in the vicinity of the exhaust top dead center, however, the amount of gas remaining in the combustion chamber decreases, and thus a residual oxygen amount decreases as well. In particular, the vicinity of the annular ignition plug is likely to be put into a fuel-excessive state by the unburned fuel being guided to the peripheral edge of the combustion chamber. As a result, no reaction of the unburned fuel may occur despite the discharge from the annular ignition plug. In this case, the unburned fuel may be discharged to the atmosphere without being controlled even by the exhaust gas control catalyst.

The disclosure provides an ignition device for an internal combustion engine with which warm-up of an exhaust gas control catalyst can be further promoted and an unburned fuel discharged to the atmosphere can be reduced in a case where the exhaust gas control catalyst is in a warm-up state.

The disclosure is to reform the unburned fuel in burned gas such that it has relatively strong oxidizability by generating nonequilibrium plasma with the ignition plug when a relatively large amount of the burned gas passes through a discharge portion of the ignition plug during the warm-up of an exhaust gas control catalyst.

An aspect relates to an ignition device for an internal combustion engine applied to an internal combustion engine provided with an exhaust gas control catalyst disposed in an exhaust passage. The ignition device includes an ignition plug including a discharge portion facing a vicinity of an exhaust port of a combustion chamber of the internal combustion engine, a drive unit configured to allow nonequilibrium plasma discharge to occur in the discharge portion by applying a drive voltage to the ignition plug, and an electronic control unit configured to allow the nonequilibrium plasma discharge to occur in the discharge portion by applying the drive voltage from the drive unit to the ignition plug in a first predetermined period when the exhaust gas control catalyst is in a warm-up state, the first predetermined period being a predetermined period after initiation of opening of an exhaust valve and a period in which a blowdown phenomenon of exhaust gas occurs.

Once the opening of the exhaust valve is initiated during an operation of the internal combustion engine, burned gas of an air-fuel mixture flows out from the inside of a cylinder to the exhaust port. In the predetermined period after the initiation of the opening of the exhaust valve as a part of a period (valve-open period) until termination of closing of the exhaust valve from the initiation of the opening of the exhaust valve, relatively high-temperature and high-pressure burned gas is present in quantity in the cylinder, and thus the pressure in the cylinder becomes higher than the pressure in the exhaust port and the pressure difference between the inside of the cylinder and the inside of the exhaust port increases. Accordingly, the so-called blowdown phenomenon in which the burned gas in the cylinder intensively flows out to the exhaust port occurs immediately after the initiation of the opening of the exhaust valve. In the period (first predetermined period) in which the blowdown phenomenon as described above occurs, a relatively large amount of the burned gas passes through the discharge portion disposed in the vicinity of the exhaust port.

In the ignition device for an internal combustion engine according to the aspect, the nonequilibrium plasma discharge is allowed to occur in the discharge portion by the drive voltage being applied from the drive unit to the ignition plug in the first predetermined period when the exhaust gas control catalyst is in the warm-up state. In the case described above, electrons with a relatively high energy generated by the nonequilibrium plasma discharge collide with a large amount of the burned gas passing through the vicinity of the discharge portion. As a result of the collision, active species with a strong reaction force such as OH radicals are generated in quantity. As a result, the active species generated as described above are likely to react with an unburned fuel (hydrocarbon) in the burned gas. Once the active species react with the unburned fuel in the burned gas, the unburned fuel is reformed into unsaturated hydrocarbon (such as olefin) or the like with relatively strong oxidizability. At least a part of the unburned fuel reformed as described above is oxidized in the exhaust passage upstream of the exhaust gas control catalyst, and thus the amount of the unburned fuel in the exhaust gas decreases. By reaction heat being generated during the oxidation of the unburned fuel, the temperature of the exhaust gas flowing into the exhaust gas control catalyst is raised. As a result, the amount of the unburned fuel in the exhaust gas can be reduced and the warm-up of the exhaust gas control catalyst can be further promoted. Although the unburned fuel that is not oxidized in the exhaust passage upstream of the exhaust gas control catalyst flows into the exhaust gas control catalyst in the middle of the warm-up, oxidation is likely to occur even by the exhaust gas control catalyst in the middle of the warm-up as the unburned fuel is reformed to have relatively strong oxidizability. The warm-up of the exhaust gas control catalyst can be further promoted by the reaction heat during the oxidation of the unburned fuel in the exhaust gas control catalyst. Therefore, according to the aspect, the warm-up of the exhaust gas control catalyst can be further promoted and the unburned fuel discharged to the atmosphere can be reduced when the exhaust gas control catalyst is in the warm-up state.

The pressure in the cylinder falls when the burned gas in the cylinder is intensively discharged to the exhaust port due to the blowdown phenomenon. In a period from the convergence of the blowdown phenomenon (termination of the first predetermined period) to the middle of an exhaust stroke, in particular, the volume of the inside of the cylinder becomes relatively large by a piston being positioned near the bottom dead center, and thus the pressure in the cylinder is likely to fall. Once a positive pressure wave attributable to the blowdown phenomenon of another cylinder or the like acts on the exhaust port of the cylinder in the state described above, the pressure in the exhaust port becomes higher than the pressure in the cylinder, and thus the exhaust gas may flow back into the cylinder from the exhaust port. The exhaust gas flowing back into the cylinder as described above is discharged back to the exhaust port due to the operation of the piston in the latter half of the exhaust stroke. At least a part of the exhaust gas flowing back into the cylinder from the exhaust port passes through the discharge portion of the ignition plug. Accordingly, once the nonequilibrium plasma discharge is allowed to occur in the discharge portion of the ignition plug in the period in which the exhaust gas flows back into the cylinder from the exhaust port, the unburned fuel contained in the exhaust gas can be reformed to have relatively strong oxidizability.

In the ignition device according to the aspect, the electronic control unit may allow the nonequilibrium plasma discharge to occur in the discharge portion by applying the drive voltage from the drive unit to the ignition plug in a second predetermined period as well as the first predetermined period when the exhaust gas control catalyst is in the warm-up state, the second predetermined period being a partial period until a middle of an exhaust stroke following termination of the first predetermined period and a period in which gas discharged from the combustion chamber to the exhaust port flows back to the combustion chamber.

According to the aspect, the unburned fuel in the burned gas can be reformed in two periods per cycle, one being the first predetermined period and the other one being the second predetermined period, and thus the unburned fuel discharged to the atmosphere can be decreased more reliably and the warm-up of the exhaust gas control catalyst can be further promoted.

Although the ignition plug according to the aspect may be disposed separately from an ignition plug for igniting the air-fuel mixture in the vicinity of the compression top dead center, it is desirable to use a single ignition plug as both the ignition plug for igniting the air-fuel mixture and the ignition plug according to the aspect. In this case, two ignition devices do not have to be disposed, and thus degradation of vehicular mountability and an increase in the number of components can be further suppressed. When a single ignition plug is used as both the ignition plug for igniting the air-fuel mixture and the ignition plug according to the aspect, the ignition of the air-fuel mixture may also be performed by the nonequilibrium plasma discharge or the ignition of the air-fuel mixture may also be performed by thermal plasma. When the ignition of the air-fuel mixture is performed by thermal plasma, the ignition plug and/or the drive unit may be configured such that forms of the discharge can be switched between the ignition of the air-fuel mixture and the reforming of the unburned fuel.

The ignition device according to the aspect may further include a detection unit configured to detect a crank position of the internal combustion engine. The electronic control unit may allow the nonequilibrium plasma discharge to occur in the discharge portion when the crank position detected by the detection unit belongs to the second predetermined period.

The ignition device according to the aspect may further include a detection unit configured to detect a crank position of the internal combustion engine. The electronic control unit may allow the nonequilibrium plasma discharge to occur in the discharge portion when the crank position detected by the detection unit belongs to the first predetermined period.

In the ignition device according to the aspect, the electronic control unit may derive the first predetermined period and the second predetermined period based on a rotation speed of the internal combustion engine and a main ignition timing.

With the ignition device for an internal combustion engine according to the aspect, the warm-up of the exhaust gas control catalyst can be further promoted and the unburned fuel discharged to the atmosphere can be effectively reduced in a case where the exhaust gas control catalyst is in the warm-up state.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram illustrating a schematic configuration of an internal combustion engine;

FIG. 2 is an enlarged view of a tip portion of an ignition plug;

FIG. 3 is a diagram illustrating a relationship among an applied voltage of the ignition plug, a pulse width, and a form of discharge;

FIG. 4 is a diagram showing a timing when nonequilibrium plasma discharge is allowed to occur by the ignition plug during warm-up promotion processing;

FIG. 5 is a timing chart illustrating a warm-up promotion processing execution timing; and

FIG. 6 is a flowchart illustrating a warm-up promotion processing execution procedure.

### DETAILED DESCRIPTION OF EMBODIMENTS

Hereinafter, a specific embodiment will be described with reference to accompanying drawings. The dimensions, materials, shapes, relative dispositions, and so on of the component parts described in the present embodiment do not limit the technical aspect to the dimensions, materials, shapes, and relative dispositions of the component parts unless otherwise noted.

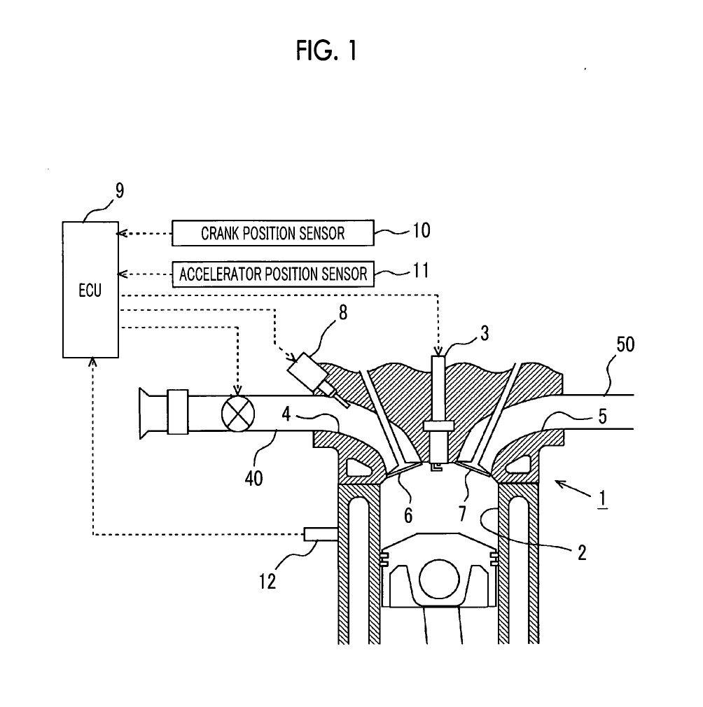

FIG. 1 is a diagram illustrating a schematic configuration of an internal combustion engine. An internal combustion engine 1 illustrated in FIG. 1 is an internal combustion engine (such as a gasoline engine) that has a plurality of cylinders 2 and performs forced ignition on an air-fuel mixture by using an ignition plug 3. The cylinder 2 that is illustrated in FIG. 1 is one of the cylinders 2.

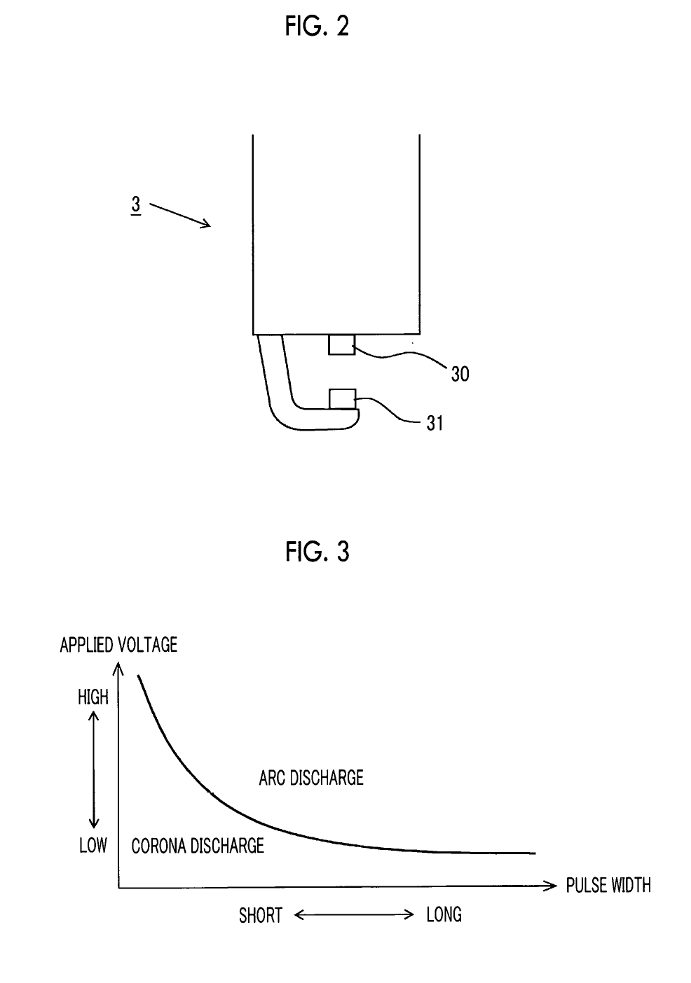

Each of the cylinders 2 of the internal combustion engine 1 has a combustion chamber in which the ceiling surface of the cylinder 2 is formed in a pent roof type. In each of the cylinders 2, a piston is accommodated to be capable of sliding in the axial direction of the cylinder 2. The ignition plug 3 is attached to each of the cylinders 2. At that time, the ignition plug 3 is attached to each of the cylinders 2 such that a tip portion of the ignition plug 3 faces the center of the combustion chamber. As illustrated in FIG. 2, a central electrode 30 and an earth electrode 31 are disposed in the tip portion of the ignition plug 3. The central electrode 30 is disposed at the center of the tip portion, and the earth electrode 31 is disposed to face the central electrode 30 via a predetermined discharge gap. Discharge occurs between the central electrode 30 and the earth electrode 31 by a drive voltage being applied to the central electrode 30. The tip portion of the ignition plug 3 including the central electrode 30 and the earth electrode 31 is an example of the “discharge portion” according to the aspect.

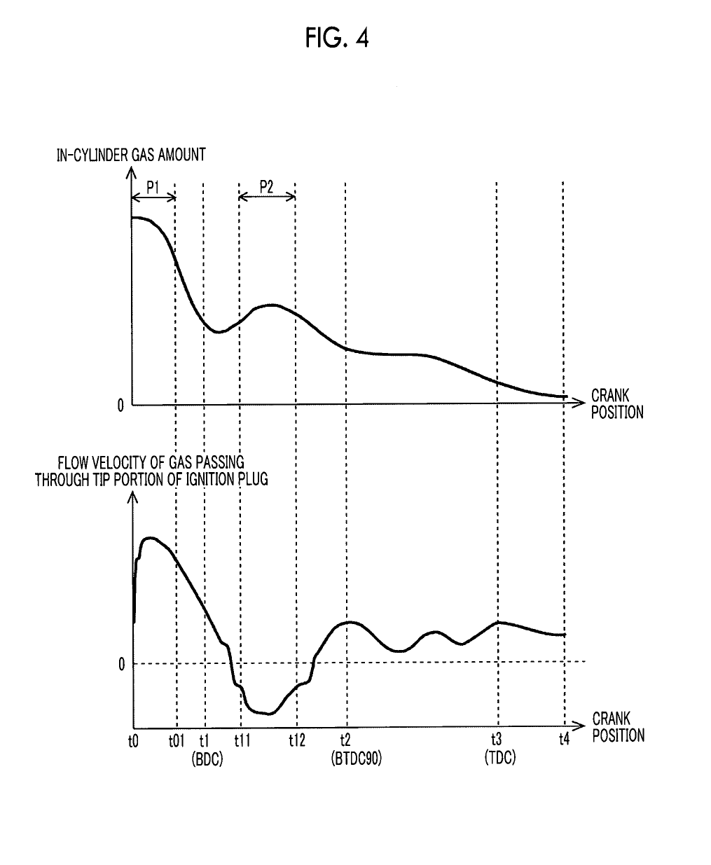

The ignition plug 3 is electrically connected to a voltage control circuit. The voltage control circuit is a circuit for controlling the voltage applied to the central electrode 30 of the ignition plug 3 and is, for example, a circuit selectively executing a mode in which thermal plasma discharge (such as arc discharge) is allowed to occur between the central electrode 30 and the earth electrode 31 of the ignition plug 3 (hereinafter, referred to as a “first discharge mode”) and a mode in which nonequilibrium plasma discharge (such as corona discharge) is allowed to occur between the central electrode 30 and the earth electrode 31 of the ignition plug 3 (hereinafter, referred to as a “second discharge mode”). Application of a long-pulse voltage to the central electrode 30 of the ignition plug 3 can be used as an example of a first discharge mode execution method. Repeated application of a short-pulse voltage to the central electrode 30 of the ignition plug 3 can be used as an example of a second discharge mode execution method. At that time, the pulse width in the second discharge mode is set such that the form of the discharge occurring between the central electrode 30 and the earth electrode 31 does not undergo a transition from corona discharge to arc discharge. A relationship among the applied voltage, the pulse width, and the form of the discharge is illustrated in FIG. 3. The region that is below the solid line in FIG. 3 is a region where the form of the discharge occurring between the central electrode 30 and the earth electrode 31 is corona discharge, and the region that is above the solid line in FIG. 3 is a region where the form of the discharge occurring between the central electrode 30 and the earth electrode 31 is arc discharge. As illustrated in FIG. 3, a transition from corona discharge to arc discharge can be avoided by the pulse width being shortened as the applied voltage increases. Accordingly, the pulse width in the second discharge mode may be set such that it is shortened as the applied voltage increases. The voltage control circuit is an example of the “drive unit” according to the aspect.

Referring back to FIG. 1, an open end of an intake port 4 and an open end of an exhaust port 5 are disposed in the ceiling surface of the combustion chamber of each of the cylinders 2 to sandwich the tip portion of the ignition plug. At that time, at least the open end of the exhaust port 5 as one of the open ends of the intake port 4 and the exhaust port 5 is disposed such that a part of the edge of the open end is close to the ignition plug 3. The intake port 4 is a port for taking air and a fuel into the cylinder 2 and is connected to an intake pipe 40. The exhaust port 5 is a port for discharging gas from the inside of the cylinder 2 and is connected to an exhaust pipe 50. The open end of the intake port 4 and the open end of the exhaust port 5 are opened and closed by an intake valve 6 and an exhaust valve 7, respectively.

A fuel injection valve 8 injecting the fuel into the intake port 4 is disposed at each of the cylinders 2 of the internal combustion engine 1. A fuel injection valve injecting a fuel into the cylinder 2 may be disposed instead of the fuel injection valve 8 at each of the cylinders 2 of the internal combustion engine 1 or the two types of fuel injection valves may be disposed at each of the cylinders 2 of the internal combustion engine 1.

The exhaust pipe 50 guides exhaust gas discharged from the inside of the cylinder 2 to the exhaust port 5 to a tail pipe (not illustrated). A catalyst casing, a silencer (not illustrated), and so on are disposed in the middle of the exhaust pipe 50. The catalyst casing accommodates an exhaust gas control catalyst activated at a predetermined temperature or a higher temperature and removing hazardous gas components from the exhaust gas. A three-way catalyst, a NO_{X} storage reduction catalyst, an oxidation catalyst, or the like can be used as the exhaust gas control catalyst.

An electronic control unit (ECU) 9 is also disposed in the internal combustion engine 1 configured as described above. The ECU 9 is an electronic control unit including a CPU, a ROM, a RAM, a backup RAM, and so on. The ECU 9 is electrically connected to various sensors such as a crank position sensor 10, an accelerator position sensor 11, an air flow meter, and a coolant temperature sensor 12. Detection signals can be input to the ECU 9 from the various sensors.

The crank position sensor 10 is configured to output an electric signal correlating with the rotational position of the output shaft (crankshaft) of the internal combustion engine 1. The accelerator position sensor 11 is configured to output an electric signal correlating with the operation amount of an accelerator pedal (accelerator operation amount). The air flow meter is configured to output an electric signal correlating with the intake air amount of the internal combustion engine 1. The coolant temperature sensor 12 is configured to output an electric signal correlating with the temperature of a coolant circulating through the internal combustion engine 1.

The ECU 9 controls various equipment such as the fuel injection valve 8 and the voltage control circuit based on the output signals of the various sensors. For example, the ECU 9 calculates a fuel injection amount (fuel injection duration) and a fuel injection timing by using an engine rotation speed calculated from the output signal of the crank position sensor 10, an engine load calculated from the output signal of the accelerator position sensor 11, and the output signal (coolant temperature) of the coolant temperature sensor 12 as parameters. The ECU 9 controls the fuel injection valve 8 in accordance with the calculated fuel injection duration and the calculated fuel injection timing. The ECU 9 calculates an ignition timing of the ignition plug 3 by using the engine rotation speed, the engine load, and the coolant temperature as parameters. The ECU 9 controls the voltage control circuit in accordance with the calculated ignition timing. The ignition timing is a timing for igniting the air-fuel mixture formed in the combustion chamber of each of the cylinders 2. For example, the ignition timing is a timing when the piston of each of the cylinders 2 is positioned close to the compression top dead center (hereinafter, the ignition timing will be referred to as a “main ignition timing”). At the main ignition timing, the ECU 9 controls the voltage control circuit such that the ignition plug 3 is operated in the first discharge mode. In a case where the internal combustion engine 1 is configured to be switchable between an operation in which an air-fuel mixture having a lean air-fuel ratio is burned (lean operation) and an operation in which an air-fuel mixture having a stoichiometric air-fuel ratio is burned (stoichiometric operation), the ECU 9 may control the voltage control circuit such that the ignition plug 3 is operated in the first discharge mode at the main ignition timing during the stoichiometric operation and the ignition plug 3 is operated in the second discharge mode at the main ignition timing during the lean operation.

The ECU 9 according to the present embodiment executes processing for further promoting the warm-up of the exhaust gas control catalyst and effectively decreasing unburned fuel discharged to the atmosphere during the warm-up of the exhaust gas control catalyst (hereinafter, referred to as “warm-up promotion processing”) as well as the various types of control described above. A method for executing the warm-up promotion processing will be described below.

The warm-up promotion processing according to the present embodiment is to reform the unburned fuel that is contained in the burned gas in the cylinder 2 such that it has relatively strong oxidizability when the exhaust gas control catalyst is in a warm-up state. Specifically, in a case where the exhaust gas control catalyst is in the warm-up state, the unburned fuel in the burned gas is reformed to have relatively strong oxidizability, into unsaturated hydrocarbon (such as olefin) or the like, by the nonequilibrium plasma discharge being allowed to occur by the ignition plug 3 when a relatively large amount of the burned gas passes through the tip portion of the ignition plug 3.

A timing when the nonequilibrium plasma discharge is allowed to occur by the ignition plug 3 during the warm-up promotion processing will be described below with reference to FIG. 4. The upper one of the graphs that are illustrated in FIG. 4 is a diagram showing a relationship between the crank position and the amount of the gas in the cylinder 2 during a valve-open period of the exhaust valve 7. The lower one of the graphs that are illustrated in FIG. 4 is a diagram showing a relationship between the crank position and the flow velocity of the gas passing through the tip portion of the ignition plug 3 during the valve-open period of the exhaust valve 7. In the example that is illustrated in FIG. 4, opening of the exhaust valve 7 is initiated at a timing (t0 in FIG. 4) earlier than the exhaust bottom dead center (t1 in FIG. 4) and closing of the exhaust valve 7 is terminated later than the exhaust top dead center (t3 in FIG. 4). In FIG. 4, the flow velocity at a time when the gas flows from the inside of the cylinder 2 to the exhaust port 5 is indicated as a positive value and the flow velocity at a time when the gas flows from the exhaust port 5 into the cylinder 2 is indicated as a negative value.

Once the opening of the exhaust valve 7 is initiated at t0 in FIG. 4, a blowdown phenomenon occurs in which the burned gas in the cylinder 2 intensively flows out to the exhaust port 5. As a result, the amount of the gas in the cylinder 2 rapidly decreases. At that time, the tip portion of the ignition plug 3 is close to the edge of the open end of the exhaust port 5, and thus a relatively large amount of the exhaust gas flowing from the inside of the cylinder 2 to the exhaust port 5 passes the vicinity of the tip portion of the ignition plug 3 due to the blowdown phenomenon. As a result, the flow velocity of the gas passing through the tip portion of the ignition plug 3 rapidly increases in a first predetermined period (period P1 from t0 to t01 in FIG. 4) after the initiation of the opening of the exhaust valve 7.

Subsequently, in the first half of an exhaust stroke (period from the exhaust bottom dead center t1 to the middle of the exhaust stroke (t2 (BTDC 90))), most of the burned gas in the cylinder 2 is discharged to the exhaust port 5 due to the blowdown phenomenon and the pressure in the cylinder 2 falls due to an increase in the volume of the inside of the cylinder 2. Once a positive pressure wave attributable to the blowdown phenomenon of another cylinder 2 or the like acts on the exhaust port 5 of the cylinder 2 in the state described above, the pressure in the exhaust port 5 becomes higher than the pressure in the cylinder 2, and thus a reverse flow of the exhaust gas from the exhaust port 5 into the cylinder 2 is generated. As a result, the flow velocity of the gas passing through the tip portion of the ignition plug 3 is changed from a positive value to a negative value, and the amount of the gas in the cylinder 2 is changed as well from a decreasing tendency to an increasing tendency. It is conceivable that a relatively large amount of the exhaust gas passes through the tip portion of the ignition plug 3 in a second predetermined period (period P2 from t11 to t12 in FIG. 4) in which the absolute value of the flow velocity of the gas passing through the tip portion of the ignition plug 3 is relatively large, which is a part of the period in which the reverse flow of the exhaust gas is generated.

Accordingly, in the warm-up promotion processing according to the present embodiment, the nonequilibrium plasma discharge is allowed to occur by the ignition plug 3 in two periods, one being the first predetermined period P1 described above and the other one being the second predetermined period P2 described above. Once the nonequilibrium plasma discharge is allowed to occur by the ignition plug 3 in the first predetermined period P1 and the second predetermined period P2 in which a relatively large amount of the burned gas (exhaust gas) passes through the tip portion of the ignition plug 3, a relatively large amount of the unburned fuel contained in the burned gas can be reformed.

The nonequilibrium plasma-based reforming of the unburned fuel is performed substantially by the following mechanism. Firstly, once the burned gas passes between the central electrode 30 and the earth electrode 31 and the vicinity of the central electrode 30 and the earth electrode 31 when the nonequilibrium plasma discharge occurs between the central electrode 30 and the earth electrode 31 of the ignition plug 3, electrons with a relatively high energy generated by the nonequilibrium plasma discharge collide with moisture or the like in the burned gas. As a result of the collision, dissociation of the moisture or the like occurs and active species such as OH radicals are generated. Once the active species generated as described above react with the unburned fuel (hydrocarbon) in the burned gas, the unburned fuel is reformed into unsaturated hydrocarbon (such as olefin) or the like with relatively strong oxidizability.

At least a part of the unburned fuel reformed by the mechanism described above is oxidized in the exhaust pipe 50 upstream of the catalyst casing. As a result, the amount of the unburned fuel in the exhaust gas is effectively decreased and the temperature of the exhaust gas flowing into the catalyst casing is further raised. As a result, the amount of the unburned fuel in the exhaust gas can be effectively reduced and the warm-up of the exhaust gas control catalyst can be further promoted. Although the unburned fuel that is not oxidized in the exhaust pipe 50 upstream of the catalyst casing flows into the exhaust gas control catalyst in the middle of the warm-up, oxidation is likely to occur even with the exhaust gas control catalyst in the middle of the warm-up as the unburned fuel is reformed to have relatively strong oxidizability. As a result, the unburned fuel in the exhaust gas can be reduced more reliably, and the warm-up of the exhaust gas control catalyst can be further promoted. Since the nonequilibrium plasma discharge is allowed to occur by the ignition plug 3 in the first predetermined period P1 and the second predetermined period P2, the amount of the unburned fuel discharged to the atmosphere can be effectively reduced during the warm-up of the exhaust gas control catalyst and the warm-up of the exhaust gas control catalyst can be further promoted as well when the amount of the unburned fuel reformed as described above increases.

The first predetermined period P1 and the second predetermined period P2 vary with the specifications and operation states of the internal combustion engine, and thus the first predetermined period P1 and the second predetermined period P2 in each operation state are obtained in advance by an experiment and simulation and are stored in the ROM of the ECU 9 in the form of a map and a function expression. The timings when the blowdown phenomenon and the reverse flow phenomenon of the exhaust gas occur vary with the engine rotation speed, the main ignition timing, and so on, and thus a map and a function expression from which the first predetermined period P1 and the second predetermined period P2 can be derived may be drawn up by the engine rotation speed and the main ignition timing being used as arguments. In a case where a variable valve mechanism capable of changing the opening and closing timings of the exhaust valve 7 is mounted, a map may be drawn up in which the opening and closing timings of the exhaust valve 7 as well as the engine rotation speed and the main ignition timing are used as arguments.

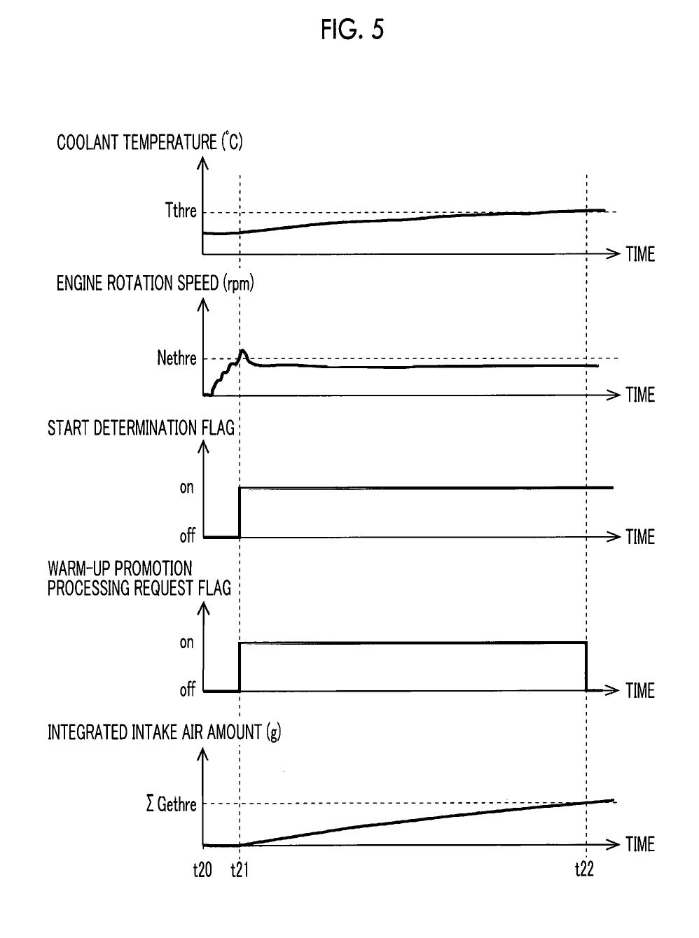

A warm-up promotion processing execution timing according to the present embodiment will be described below with reference to FIG. 5. FIG. 5 is a diagram showing how the coolant temperature, the engine rotation speed, a start determination flag, a warm-up promotion processing request flag, and an integrated intake air amount change over time in the period from the initiation of the start of the internal combustion engine 1 (t20 in FIG. 5) to the completion of the warm-up of the exhaust gas control catalyst (t22 in FIG. 5). The start determination flag is a flag turned off when the operation of the internal combustion engine 1 is stopped and turned on when the restart of the internal combustion engine 1 is completed. The warm-up promotion processing request flag is a flag turned on based on a determination that the exhaust gas control catalyst is not active when the start of the internal combustion engine 1 is completed and turned off based on a determination that the exhaust gas control catalyst is active subsequently. The integrated intake air amount is the integrated value of the intake air amount starting from the completion of the start of the internal combustion engine 1.

The engine rotation speed begins to rise once the start of the internal combustion engine 1 is initiated (t20 in FIG. 5). Once the engine rotation speed rises to at least a start determination value Nethre (t21 in FIG. 5), the ECU 9 determines that the start of the internal combustion engine 1 is completed and switches the start determination flag from off to on. When the coolant temperature detected by the coolant temperature sensor 12 is lower than a threshold Tthre at that time, the ECU 9 determines that the exhaust gas control catalyst is not active, switches the warm-up promotion processing request flag from off to on, and initiates the calculation of the integrated intake air amount. The threshold Tthre is a value with which the temperature of the exhaust gas control catalyst is estimated to be lower than an activation temperature when the coolant temperature is lower than the threshold Tthre. The warm-up promotion processing is initiated once the warm-up promotion processing request flag is switched from off to on. Subsequently, once the integrated intake air amount reaches or exceeds a warm-up completion determination value ΣGathre (t22 in FIG. 5), the warm-up promotion processing request flag is switched from on to off and the warm-up promotion processing is terminated as a result. The warm-up completion determination value ΣGathre is an integrated intake air amount needed until the completion of the warm-up of the exhaust gas control catalyst (until the temperature of the exhaust gas control catalyst becomes equal to or higher than the activation temperature) and is set such that it increases as the coolant temperature at the completion of the start of the internal combustion engine 1 decreases.

The amount of the unburned fuel discharged to the atmosphere in the period in which the exhaust gas control catalyst is in the warm-up state can be effectively reduced once the warm-up promotion processing is executed in the period until the warm-up promotion processing request flag is turned off after being turned on (period from t21 to t22 in FIG. 5), that is, in the period from the completion of the start of the internal combustion engine 1 to the completion of the warm-up of the exhaust gas control catalyst as illustrated in FIG. 5. Since the warm-up of the exhaust gas control catalyst is also promoted by the execution of the warm-up promotion processing as described above, the warm-up completion determination value ΣGathre is determined in view of the above-described effect of the promotion of the warm-up of the exhaust gas control catalyst resulting from the warm-up promotion processing as well. Once the warm-up completion determination value ΣGathre is determined as described above, longer-than-necessary execution of the warm-up promotion processing is also suppressed. The timing of the termination of the warm-up promotion processing may also be determined by an estimated value of the temperature of the exhaust gas control catalyst being used as a parameter instead of the integrated intake air amount. For example, the warm-up promotion processing may be terminated when the estimated temperature of the exhaust gas control catalyst is equal to or higher than the activation temperature of the exhaust gas control catalyst. The temperature of the exhaust gas control catalyst can be estimated by, for example, an exhaust gas temperature sensor being installed in at least one of the exhaust pipe 50 upstream of the catalyst casing and the exhaust pipe 50 downstream of the catalyst casing and the temperature of the exhaust gas control catalyst being estimated from the temperature of the exhaust gas detected by the exhaust gas temperature sensor.

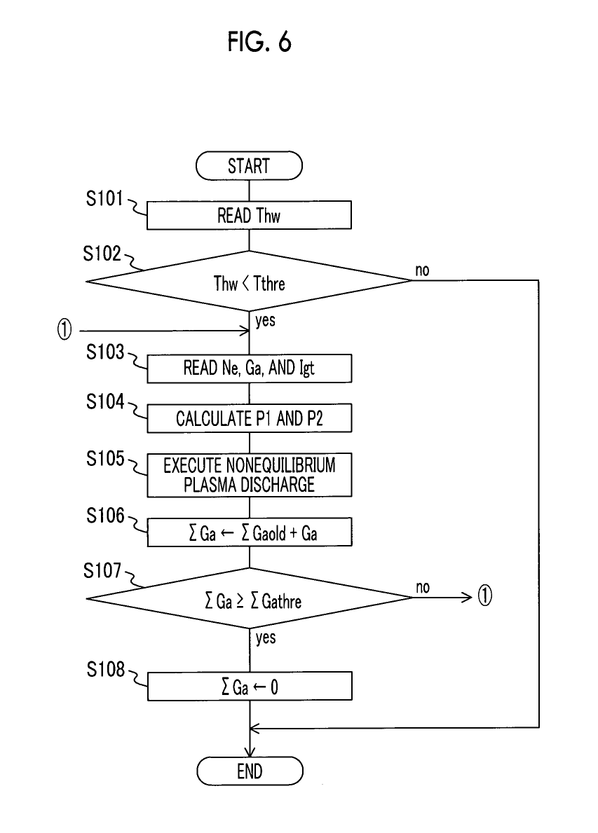

Hereinafter, a warm-up promotion processing execution procedure according to the present embodiment will be described with reference to FIG. 6. FIG. 6 is a flowchart showing a processing routine executed by the ECU 9 and triggered by the completion of the start of the internal combustion engine 1, that is, switching of the start determination flag from off to on. The processing routine is stored in advance in the ROM of the ECU 9 or the like.

In the processing routine illustrated in FIG. 6, the ECU 9 firstly reads an output signal (coolant temperature) Thw of the coolant temperature sensor 12 in the processing of S101. The coolant temperature Thw read in the processing of S101 corresponds to the coolant temperature at the timing of t21 in FIG. 5 described above.

In the processing of S102, the ECU 9 determines whether or not the coolant temperature Thw read in the processing of S101 is lower than the threshold Tthre. As described above, the threshold Tthre is a value with which the temperature of the exhaust gas control catalyst is estimated to be lower than the activation temperature when the coolant temperature is lower than the threshold Tthre. In the case of a negative determination in the processing of S102, the ECU 9 is capable of estimating that the temperature of the exhaust gas control catalyst is equal to or higher than the activation temperature (estimating that the exhaust gas control catalyst is in a warm-up completion state), and thus the ECU 9 terminates the processing routine without executing the warm-up promotion processing. In the case of a positive determination in the processing of S102, the ECU 9 is capable of estimating that the temperature of the exhaust gas control catalyst is lower than the activation temperature (estimating that the exhaust gas control catalyst is in the warm-up state), and thus the ECU 9 executes the warm-up promotion processing in the processing following S103.

During the execution of the warm-up promotion processing, the ECU 9 first reads an intake air amount Ga needed for the calculation of the integrated intake air amount in addition to an engine rotation speed Ne and a main ignition timing Igt as parameters for the calculation of the first predetermined period P1 and the second predetermined period P2 in the processing of S103.

In the processing of S104, the ECU 9 derives the first predetermined period P1 and the second predetermined period P2 by using the engine rotation speed Ne and the main ignition timing Igt read in the processing of S103 as arguments. At that time, a map and a function expression for deriving the first predetermined period P1 and the second predetermined period P2 by using the engine rotation speed Ne and the main ignition timing Igt as arguments are stored in advance in the ROM of the ECU 9 as described above. The first predetermined period P1 and the second predetermined period P2 derived herein are specified by the crank position.

In the processing of S105, the ECU 9 controls the voltage control circuit such that the nonequilibrium plasma discharge is allowed to occur by the ignition plug 3 in the first predetermined period P1 and the second predetermined period P2 derived in the processing of S104. Specifically, the ECU 9 allows the nonequilibrium plasma discharge to occur between the central electrode 30 and the earth electrode 31 by repeatedly applying a short-pulse voltage to the central electrode 30 of the ignition plug 3 at each of a time when the crank position detected by the crank position sensor 10 belongs to the first predetermined period P1 and a time when the crank position detected by the crank position sensor 10 belongs to the second predetermined period P2. As a result, the unburned fuel in the burned gas is reformed to have relatively strong oxidizability in the period in which the blowdown phenomenon of the exhaust gas occurs (first predetermined period P1) and the period in which the reverse flow phenomenon by a relatively large amount of the exhaust gas occurs (second predetermined period P2). Accordingly, the amount of the unburned fuel in the exhaust gas can be effectively reduced and the warm-up of the exhaust gas control catalyst can be further promoted.

In the processing of S106, the ECU 9 calculates an integrated intake air amount ΣGa from the completion of the start of the internal combustion engine 1 to the present point in time by adding the intake air amount Ga read in the processing of S103 to a previously calculated value ΣGaold of the integrated intake air amount. The integrated intake air amount ΣGa is the integrated value of the intake air amount starting from the completion of the start of the internal combustion engine 1 as described above.

In the processing of S107, the ECU 9 determines whether or not the integrated intake air amount ΣGa calculated in the processing of S106 is equal to or larger than the warm-up completion determination value ΣGathre. As described above, the warm-up completion determination value ΣGathre is the integrated value of the intake air amount needed until the completion of the warm-up of the exhaust gas control catalyst from the completion of the start of the internal combustion engine 1 and is determined in view of the effect of the promotion of the warm-up of the exhaust gas control catalyst resulting from the warm-up promotion processing as well. In the case of a positive determination in the processing of S107, the ECU 9 is capable of estimating that the warm-up of the exhaust gas control catalyst is completed (the temperature of the exhaust gas control catalyst rises to at least the activation temperature), and thus the ECU 9 terminates the execution of the warm-up promotion processing. In other words, the ECU 9 resets the calculated value of the integrated intake air amount ΣGa to “0” in the processing of S108 and terminates the processing of the processing routine. In the case of a negative determination in the processing of S107, the ECU 9 is capable of estimating that the warm-up of the exhaust gas control catalyst is not completed (the temperature of the exhaust gas control catalyst is lower than the activation temperature), and thus the ECU 9 returns to the processing of S103 and continues to execute the warm-up promotion processing.

The “electronic control unit” according to the aspect is realized by the ECU 9 executing the processing routine illustrated in FIG. 6 as described above. As a result, the warm-up of the exhaust gas control catalyst can be further promoted and the unburned fuel discharged to the atmosphere can be effectively reduced when the exhaust gas control catalyst is in the warm-up state.

Although an example in which the nonequilibrium plasma discharge is allowed to occur by the ignition plug 3 in the two periods, one being the first predetermined period P1 and the other one being the second predetermined period P2, has been described in the present embodiment, the nonequilibrium plasma discharge may also be allowed to occur by the ignition plug 3 in one of the first predetermined period P1 and the second predetermined period P2. In the above-described case, the nonequilibrium plasma discharge may be allowed to occur by the ignition plug 3 solely in the first predetermined period P1, when the amount of the burned gas passing through the tip portion of the ignition plug 3 is relatively large. When the warm-up promotion processing is executed by the method described above, electric power consumption resulting from the operation of the ignition plug 3 can be kept at a low level although the effect of unburned fuel reduction is less significant than by the method by which the nonequilibrium plasma discharge occurs in the first predetermined period P1 and the second predetermined period P2 alike.

Although the ignition plug switchable between the thermal plasma discharge and the nonequilibrium plasma discharge has been described as an example of the ignition plug according to the aspect in the present embodiment, an ignition plug with which the nonequilibrium plasma discharge alone can occur can also be used instead. In this case, the air-fuel mixture may be ignited by the occurrence of the nonequilibrium plasma discharge even at the main ignition timing.

What is claimed is:

1. An ignition device for an internal combustion engine provided with an exhaust gas control catalyst disposed in an exhaust passage, the ignition device comprising:
an ignition plug including a discharge portion facing a vicinity of an exhaust port of a combustion chamber of the internal combustion engine;
a drive unit configured to allow nonequilibrium plasma discharge to occur in the discharge portion by applying a drive voltage to the ignition plug; and
an electronic control unit configured to allow the nonequilibrium plasma discharge to occur in the discharge portion by applying the drive voltage from the drive unit to the ignition plug in a first predetermined period when the exhaust gas control catalyst is in a warm-up state, the first predetermined period being a predetermined period after initiation of opening of an exhaust valve and a period in which a blowdown phenomenon of exhaust gas occurs.

2. The ignition device according to claim 1, wherein the electronic control unit allows the nonequilibrium plasma discharge to occur in the discharge portion by applying the drive voltage from the drive unit to the ignition plug in a second predetermined period as well as the first predetermined period when the exhaust gas control catalyst is in the warm-up state, the second predetermined period being a partial period until a middle of an exhaust stroke following termination of the first predetermined period and a period in which gas discharged from the combustion chamber to the exhaust port flows back to the combustion chamber.

3. The ignition device according to claim 2, further comprising a detection unit configured to detect a crank position of the internal combustion engine,
wherein the electronic control unit allows the nonequilibrium plasma discharge to occur in the discharge portion when the crank position detected by the detection unit belongs to the second predetermined period.

4. The ignition device according to claim 1, further comprising a detection unit configured to detect a crank position of the internal combustion engine,
wherein the electronic control unit allows the nonequilibrium plasma discharge to occur in the discharge portion when the crank position detected by the detection unit belongs to the first predetermined period.

5. The ignition device according to claim 2, wherein the electronic control unit derives the first predetermined period and the second predetermined period based on a rotation speed of the internal combustion engine and a main ignition timing.
